(19) United States
(12) Patent Application Publication
(10) Pub. No.: US 2002/0146507 A1
(43) Pub. Date: Oct. 10, 2002

(54) Method of treatment of compressed sponges (sponge cards) without affecting their size and thickness (without causing them to expand or swell)

(76) Inventor: James Thomas Boyd, Plainfield, IL (US)

Correspondence Address: James T. Boyd, 25665 Caton Farm Rd., Plainfield, IL, 60544, US

(21) Appl. No.: 09/828,420

(22) Filed: Apr. 9, 2001

(51) Int. Cl. G01N 1/00

(52) U.S. Cl. 427/180

(57) ABSTRACT

Carpeting, upholstery, clothing, and other textile fibers and hard surfaces are spot cleaned, emergency spot cleaned, and/or maintenance cleaned with a sponge, that has already been treated with the appropriate cleaner, deodorizer, and/or other treatment, that was and remained a compressed sponge (sponge card) and did not expand into a usable size sponge until it was hydrated (moistened) at time of use made possible by treating the compressed sponge (sponge card) with dehydrated cleaner, deodorizer, and/or other treatment which does not cause it to expand (swell) at time of treatment. The treated compressed sponge (sponge card) is able to remain a convenient flat size until hydrated (moistened) at time of use.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

There are myriad types of cleaners and cleaning methods for cleaning textile fibers and hard surfaces. Most of these require the cleaner, usually a liquid or paste, be either applied to a cloth, sponge, brush or other type of applicator or applied directly to the surface to be cleaned and then either worked and wiped with a cloth, sponge, or brush, or agitated and rinsed away.

Cleaning of textile fabrics and hard surfaces, especially in an emergency or maintenance situation, is usually complicated requiring at least two separate products, the cleaner and the applicator. This can be very difficult to have with you when needed as it can be very cumbersome and even carry risk of leaking.

Most people do not want to carry a container of cleaner and a sponge in their pocket or purse for emergency clean up of pet, baby, or food drip accidents. It would be too large and inconvenient and would usually be a liquid that would have the dangerous risk of leaking.

The need has existed for a convenient product that has the cleaner/deodorizer/and/or other treatment agent incorporated in the applicator in a compact form. This need could have been met with a compressed sponge (sponge card) pre-treated with the treatment agent so it could then be conveniently stored and /or carried until used and then could be disposed of after use. The problem has always been that when treated the compressed sponge (sponge card) would expand (swell) into a sponge and cease being convenient.

### BRIEF SUMMARY OF THE INVENTION

It is therefore the object of the present invention to provide a compressed sponge that is treated with the appropriate cleaner, deodorizer, and/or other treatment that has not expanded and will not expand (swell) until it is moistened with water and becomes a sponge at the time of use.

It is a further object of the present invention to provide a complete cleaning instrument that is compact making it extremely convenient to store and/or carry.

It is also an object of the present invention to provide a method of cleaning that will absorb the soil/object and then can be conveniently disposed of into the proper trash containers.

### BRIEF DESCRIPTION OF THE SEVERAL VIEWS OF THE DRAWING

“Not Applicable”

### DETAILED DESCRIPTION OF THE INVENTION

What has been invented here is a way of treating a compressed sponge with cleaner, deodorizer and/or other treatment without causing the compressed sponge to expand into a full size sponge. (The compressed sponge (sponge card) will not expand until it is moistened so it remains compact and convenient.)

This is accomplished by dehydrating the cleaner/deodorizer/other treatment before it is applied to the compressed sponge or using cleaner/deodorizer/other treatment that has very little water content This then allows the compressed sponge (sponge card) to remain compressed and very thin until it is moistened at time of use.

Pet owners can easily and conveniently carry a treated compressed sponge (sponge card) in their pocket, purse, car, etc. When there is a pet accident all they have to do is moisten the card and it becomes a full size treated sponge with which they clean up the problem and throw it away. The cleaner and deodorizer is already in the sponge.

Treated compressed sponges (sponge cards) can easily and conveniently be carried in a diaper bag. If there is a spit up accident all that is needed is to moisten a treated card and it becomes a full size treated sponge with which to clean up the problem and throw it away. The cleaner and deodorizer is already in the sponge.

The concept can be adapted to meet many needs and applications by treating the compressed sponge (sponge card) with the appropriate dehydrated product.

1. What I claim as my invention is a way to treat compressed sponges (sponge cards) with various cleaner, deodorizer, and/or other treatment without causing the compressed sponges to expand (swell) into a normal size sponge by dehydrating the cleaner, deodorizer, and/or other treatment before applying it to the compressed sponge (sponge card).

2. The treatment described in claim 1 may be a product that is already dehydrated or in a very low moisture form.
